(19) United States
(12) Patent Application Publication
(10) Pub. No.: US 2009/0002455 A1
(43) Pub. Date: Jan. 1, 2009

(54) HEAD CHIP USABLE WITH INKJET IMAGE FORMING APPARATUS AND MANUFACTURING METHOD OF THE SAME

(75) Inventors: Jae Sik MIN, Suwon-si (KR); Ohyun BEAK, Seoul (KR); Chang Shin PARK, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/132,015

(22) Filed: Jun. 3, 2008

(30) Foreign Application Priority Data
Jun. 27, 2007 (KR) 2007-63614

(51) Int. Cl. B41J 2/05

(52) U.S. Cl. 347/56; 29/890.1

(57) ABSTRACT

A head chip for an inkjet image forming apparatus. The head chip can include a heater formed on a substrate to generate heat, a chamber layer formed on the heater and provided with an ink chamber that receives inks, a nozzle layer formed on the chamber layer and provided with a nozzle in correspondence with the ink chamber, and a heat transfer layer transferring a part of the heat from the heater to the nozzle. According to the head chip, the inks sprayed through the nozzle are heated by the heat transferred through the heat transfer layer. Thus, the viscosity of the inks is reduced, so that the inks can be easily cut into ink droplets having a substantially spherical shape.

### CROSS-REFERENCE TO RELATED APPLICATIONS

This application claims the benefit of Korean Patent Application No. 2007-63614, filed on Jun. 27, 2007, in the Korean Intellectual Property Office, the disclosure of which is incorporated herein by reference in its entirety.

### BACKGROUND OF THE INVENTION

1. Field of the Invention

The present general inventive concept relates generally to a head chip usable with an inkjet image forming apparatus. More particularly, the present general inventive concept relates to a head chip usable with a thermal-driving type inkjet image forming apparatus and a manufacturing method thereof.

2. Description of the Related Art

In general, an inkjet image forming apparatus forms an image by spraying ink onto a printing medium such as a sheet. A head chip for a conventional inkjet image forming apparatus comprises a head chip for a thermal-driving type inkjet image forming apparatus disclosed in a Korean Unexamined Patent Publication No. 2006-133127, which comprises a substrate, a heater that generates heat, a chamber layer provided with an ink chamber that receives inks, and a nozzle layer provided with a nozzle for spraying the inks so as to generate bubbles in the ink of the ink chamber by the heat generated from the heater, thereby ejecting the ink from the nozzle by expansion force of the bubbles.

Since the inks used for the head chip for the conventional inkjet image forming apparatus are liquid with viscosity, ink droplets ejected through the nozzle have an elongated shape in the appearance of tails. Further, dots formed by the elongated ink droplets have an oval shape. Thus, a printed matter of high resolution may not be obtained through such oval-shaped dots.

### SUMMARY OF THE INVENTION

The present general inventive concept provides an inkjet image forming apparatus capable of producing ink droplets having a substantially spherical shape.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept can be achieved by providing a head chip usable with an inkjet image forming apparatus including a heater formed on a substrate to generate heat, a chamber layer formed on the heater and provided with an ink chamber that receives inks, a nozzle layer formed on the chamber layer and provided with a nozzle in correspondence with the ink chamber, and a heat transfer layer transferring a part of the heat from the heater to the nozzle.

The heat transfer layer may include a first heat transfer section formed through the chamber layer and having a first end adjacent to the heater, and a second heat transfer section extending from a second end of the first heat transfer section to the nozzle.

The head chip may further include an adiabatic layer isolating the substrate from the heater, and a heater protection layer protecting the heater by covering the heater.

The head chip may further include an anti-cavitation layer that prevents corrosion due to heat and inks by forming a bottom surface of the ink chamber.

The first end of the first heat transfer section makes contact with the anti-cavitation layer.

Further, heat transfer holes can be formed through the chamber layer at both sides of the ink chamber of the chamber layer to form the first heat transfer section.

The foregoing and/or other aspects and utilities of the general inventive concept can be achieved by providing a manufacturing method of a head chip usable with an inkjet image forming apparatus, the method including forming a heater on a substrate, forming a chamber layer having an ink chamber, which receives inks, and heat transfer holes to transfer heat, which is generated from the heater, through the chamber layer, forming a first heat transfer section in the heat transfer holes such that heat is transferred through the chamber layer, forming a sacrificial layer in the ink chamber, forming a second heat transfer section, which receives the heat from the first heat transfer section, on the first heat transfer section and the sacrificial layer, forming a nozzle layer provided with a nozzle on the chamber layer and the second heat transfer section, and removing the sacrificial layer.

Further, after forming the adiabatic layer on the substrate, the heater is formed on an adiabatic layer.

Further, after forming a heater protection layer to protect the heater on the heater and forming an anti-cavitation layer for oxidation prevention on the heater protection layer, the chamber layer is formed on the anti-cavitation layer.

The foregoing and/or other aspects and utilities of the general inventive concept can be achieved by providing a head chip usable with an inkjet image forming apparatus including a heater formed on a substrate to generate heat; an ink flow region formed on the substrate to contain ink to be ejected; a nozzle layer formed above the ink flow region and provided with a nozzle in correspondence with the ink flow region; and a heat transfer layer to transfer a part of the heat from the heater to the nozzle.

The ink flow region contains ink therein and flows ink through the head chip to the nozzles.

The foregoing and/or other aspects and utilities of the general inventive concept can be achieved by providing a manufacturing method of a head chip usable with an inkjet image forming apparatus, the method including: forming a heater on a substrate; forming an ink flow region including heat transfer holes to transfer heat generated from the heater, therethrough; forming a first heat transfer section in the heat transfer holes such that heat is transferred through the ink flow region; forming a sacrificial layer in the ink flow region; forming a second heat transfer section to receive the heat from the first heat transfer section and extending across a portion of the sacrificial layer; forming a nozzle layer provided with a nozzle over the sacrificial layer and the second heat transfer section; and removing the sacrificial layer.

### BRIEF DESCRIPTION OF THE DRAWINGS

The above and other objects, features and utilities of the present general inventive concept will be more apparent from the following detailed description taken in conjunction with the accompanying drawings, in which:

FIG. 1 is a sectional view illustrating a head chip of an inkjet image forming apparatus according to an embodiment of the present general inventive concept; and

FIGS. 2 and 5 are sectional views illustrating a manufacturing method of a head chip for an inkjet image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

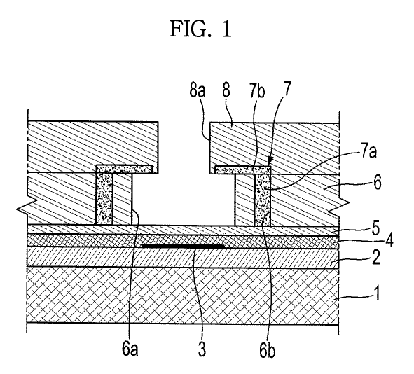

As illustrated in FIG. 1, a head chip usable with an inkjet image forming apparatus according to an embodiment of the present general inventive concept includes a silicon substrate 1, a heater 3 that generates heat by using supplied power, an adiabatic layer 2, a heater protection layer 4, an anti-cavitation layer 5, a chamber layer 6 and a nozzle layer 8. The adiabatic layer 2 is formed between the heater 3 and the substrate 1 to isolate the heater 3 from the substrate 1. The heater protection layer 4 is formed on the heater 3 to protect the heater 3. The anti-cavitation layer 5 includes metal material such as tantalum and can be formed on the heater protection layer 4 to prevent surface oxidation caused by heat or inks. The chamber layer 6 can be formed on the anti-cavitation layer 5 to form an ink chamber 6a that receives the ink. The nozzle layer 8 is formed on the chamber layer 6 and has an ink spray nozzle 8a corresponding to the ink chamber 6a. At this time, the chamber layer 6 provided with the ink chamber 6a is formed on the anti-cavitation layer 5, so that the anti-cavitation layer 5 forms the bottom surface of the ink chamber 6a.

Further, the head chip for the inkjet image forming apparatus according to the present embodiment includes a heat transfer layer 7 that heats the inks sprayed through the nozzle 8a by transferring the heat from the heater 3 to the nozzle 8a.

The heat transfer layer 7 has one end adjacent to the heater 3 to receive the heat generated from the heater 3, and the other end extending to the nozzle 8a. Thus, a part of the heat generated from the heater 3 is transferred to the nozzle 8a, so that the inks passing through the nozzle 8a can be heated. According to the present embodiment, the heat transfer layer 7 includes first heat transfer sections 7a and second heat transfer sections 7b. The first heat transfer section 7a is formed through the chamber layer 6 and has one end making contact with the anti-cavitation layer 5 to receive the heat generated from the heater 3. The second heat transfer section 7b extends to the nozzle 8a from the other end of the first heat transfer section 7a. At this time, heat transfer holes 6b formed through the chamber layer 6 are provided at both sides of the ink chamber 6a of the chamber layer 6, so that the first heat transfer sections 7a can be formed in the heat transfer holes 6b using photosensitive Ag paste.

A part of the heat generated from the heater 3 is transferred to the nozzle 8a through the heat transfer layer 7, so that the inks sprayed/ejected through the nozzle 8a are heated. Since viscosity of liquid is reduced proportionally to temperature of the liquid, the viscosity of the inks is also reduced, so that the inks sprayed through the nozzle 8a are cut with a short length due to low viscosity. In other words, ink droplets can be ejected to any size due to a low viscosity of the ink. Thus, ink droplets having a substantially spherical shape can be obtained. Consequently, dots approximate to a circle required for acquiring a printed matter of high resolution can be obtained.

Hereinafter, a manufacturing method of the head chip usable with the inkjet image forming apparatus having the construction as described above will be described, according to another embodiment of the present general inventive concept.

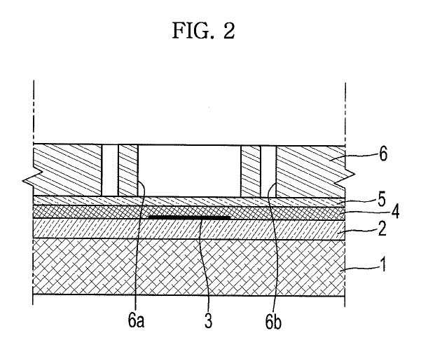

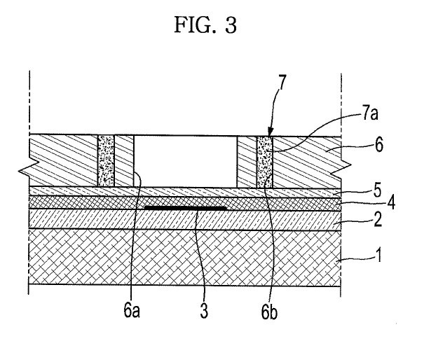

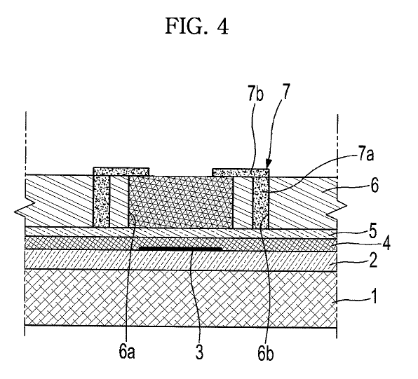

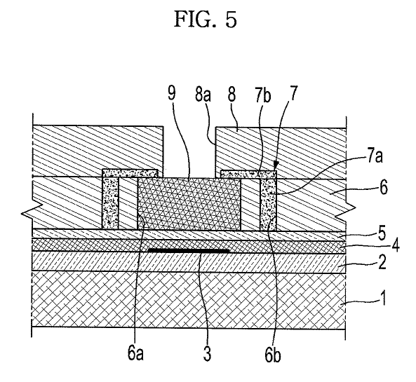

As illustrated in FIG. 2, after forming an adiabatic layer 2 comprising SiOₓ on a silicon substrate 1, a heater 3 is formed on the adiabatic layer 2 and a heater protection layer 4 including SiNₓ is formed on the heater 3. Then, an anti-cavitation layer 5 including tantalum is formed on the heater protection layer 4 to prevent oxidation, and a chamber layer 6 having an ink chamber 6a and heat transfer holes 6b is formed. As illustrated in FIG. 3, first heat transfer sections 7a of the heat transfer layer 7 are formed by filling photosensitive Ag paste in the heat transfer holes 6b. As illustrated in FIG. 4, after filling the ink chamber 6a with a sacrificial layer 9 to be removed, second heat transfer sections 7b of the heat transfer layer 7 are formed on the first heat transfer sections 7a and the sacrificial layer 9. As illustrated in FIG. 5, a nozzle layer 8 provided with a nozzle 8a is formed on the chamber layer 6 and the second heat transfer section 7b, and the sacrificial layer 9 is finally removed from the ink chamber 6a, thereby completing fabrication of the head chip for the inkjet image forming apparatus as illustrated in FIG. 1.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A head chip usable with an inkjet image forming apparatus comprising:
a heater formed on a substrate to generate heat;
a chamber layer formed on the heater and provided with an ink chamber that receives inks;
a nozzle layer formed on the chamber layer and provided with a nozzle in correspondence with the ink chamber; and
a heat transfer layer to transfer a part of the heat from the heater to the nozzle.

2. The head chip as claimed in claim 1, wherein the heat transfer layer comprises:
a first heat transfer section formed through the chamber layer and having a first end adjacent to the heater; and
a second heat transfer section extending from a second end of the first heat transfer section to the nozzle.

3. The head chip as claimed in claim 1, further comprising:
an adiabatic layer isolating the substrate from the heater; and
a heater protection layer to protect the heater by covering the heater.

4. The head chip as claimed in claim 2, further comprising:
an anti-cavitation layer that prevents corrosion due to heat and inks by forming a bottom surface of the ink chamber.

5. The head chip for an inkjet image forming apparatus as claimed in claim 4, wherein the first end of the first heat transfer section makes contact with the anti-cavitation layer.

6. The head chip as claimed in claim 2, wherein heat transfer holes are formed through the chamber layer at both sides of the ink chamber of the chamber layer to form the first heat transfer section.

7. A manufacturing method of a head chip usable with an inkjet image forming apparatus, the method including:
forming a heater on a substrate;
forming a chamber layer having an ink chamber, which receives inks, and heat transfer holes for transferring heat, which is generated from the heater, through the chamber layer;
forming a first heat transfer section in the heat transfer holes such that heat is transferred through the chamber layer;
forming a sacrificial layer in the ink chamber;
forming a second heat transfer section, which receives the heat from the first heat transfer section, on the first heat transfer section and the sacrificial layer;
forming a nozzle layer provided with a nozzle on the chamber layer and the second heat transfer section; and
removing the sacrificial layer.

8. The method as claimed in claim 7, wherein, after forming the adiabatic layer on the substrate, the heater is formed on an adiabatic layer.

9. The method as claimed in claim 7, wherein, after forming a heater protection layer for protecting the heater on the heater and forming an anti-cavitation layer for oxidation prevention on the heater protection layer, the chamber layer is formed on the anti-cavitation layer.
